(19) United States
(12) Patent Application Publication
(10) Pub. No.: US 2007/0049297 A1
(43) Pub. Date: Mar. 1, 2007

(54) System and method for locating mobile devices through a direct-connection protocol

(76) Inventors: Janakiraman Gopalan, Cupertino, CA (US); Varadachari Rengarajan, Cupertino, CA (US)

Correspondence Address: FAY KAPLUN & MARCIN, LLP, 15O BROADWAY, SUITE 702, NEW YORK, NY, 10038, US

(21) Appl. No.: 11/215,493

(22) Filed: Aug. 29, 2005

(51) Int. Cl. H04Q 7/20

(52) U.S. Cl. 455/456.5

(57) ABSTRACT

Described is a system and method for retrieving information from a direct connection protocol (“DCP”) server, the information including a unique identifier for a mobile device, wherein the DCP server received the information in a communication from the mobile device. A correlation is maintained between the DCP server and a site and an indication is stored that the mobile device is located at the site based on the retrieving of the information from the DCP server correlated to the site.

### BACKGROUND INFORMATION

Mobile computing devices are becoming more powerful and expensive. A problem with such mobile devices is that, due to their small size and/or light weight, they are easily transported but difficult to track. For example, large corporations may own thousands of mobile devices which are scattered throughout their organization in various geographical locations. Within these locations, mobile devices are not always stored in a controlled, central location. As a result, devices are often misplaced, lost or even stolen by employees who are not associated with a specific device and thus not held responsible for the management of the devices which they operate.

Adding to the difficulty of mobile device management are problems such as hoarding of devices by individual groups within an organization. For example, departments within a retail store may hoard devices to ensure themselves the proper amount of resources to meet their needs. Organizations may also keep a large amount of spare devices to replace devices that may have been sent out for repair. Consequently, tracking and monitoring of mobile devices can become burdensome.

Conventional asset tracking systems are built around a central database designed to store information related to the identity and status of various devices. Updating of such a database requires manual operation of on-site appliances such as beacons, control computers and/or security monitor devices. For a large retail chain with a wide distribution of geographical locations, this kind of tracking is time consuming and consequently expensive. Minimization of costs is an important consideration in the modern business environment. Thus, it would be desirable to provide a computer based system for automatically gathering, analyzing, and storing information relating to the status and location of assets, such as a plurality of mobile devices, so as to reduce administrative burdens and operating costs associated with such assets.

### SUMMARY OF THE INVENTION

A method for retrieving information from a direct connection protocol (“DCP”) server, the information including a unique identifier for a mobile device, wherein the DCP server received the information in a communication from the mobile device. A correlation is maintained between the DCP server and a site and an indication is stored that the mobile device is located at the site based on the retrieving of the information from the DCP server correlated to the site.

A system having a mobile device and a direct connection protocol (“DCP”) server receiving information from the mobile device, wherein the information includes a unique identifier for the mobile device. The system further includes an enterprise management system maintaining a correlation between the DCP server and a site, wherein the enterprise management system retrieves the information and determines a location for the mobile device based on the correlation and the unique identifier, the enterprise management system storing the location of the mobile device.

A method for storing a plurality of records, each record corresponding to a mobile device connected to a network and also storing a plurality of correlations between a plurality of sites and a plurality of direct connection protocol (“DCP”) servers. Information is retrieved from one of the DCP servers, wherein the information includes a unique identifier for at least one of the mobile devices. Location data is then stored in the record corresponding to the at least one mobile device, wherein the location data is determined based on the correlation between the one of the DCP servers and the corresponding site.

### BRIEF DESCRIPTION OF DRAWINGS

FIG. 1 shows an exemplary embodiment of a direct-connection protocol server tracking system according to the present invention.

FIG. 2 shows an exemplary embodiment of a method according to the present invention.

### DETAILED DESCRIPTION

The present invention may be further understood with reference to the following description and the appended drawings, wherein like elements are referred to with the same reference numerals. The present invention provides a system and a method for efficiently locating and managing mobile devices through a direct-connection protocol server.

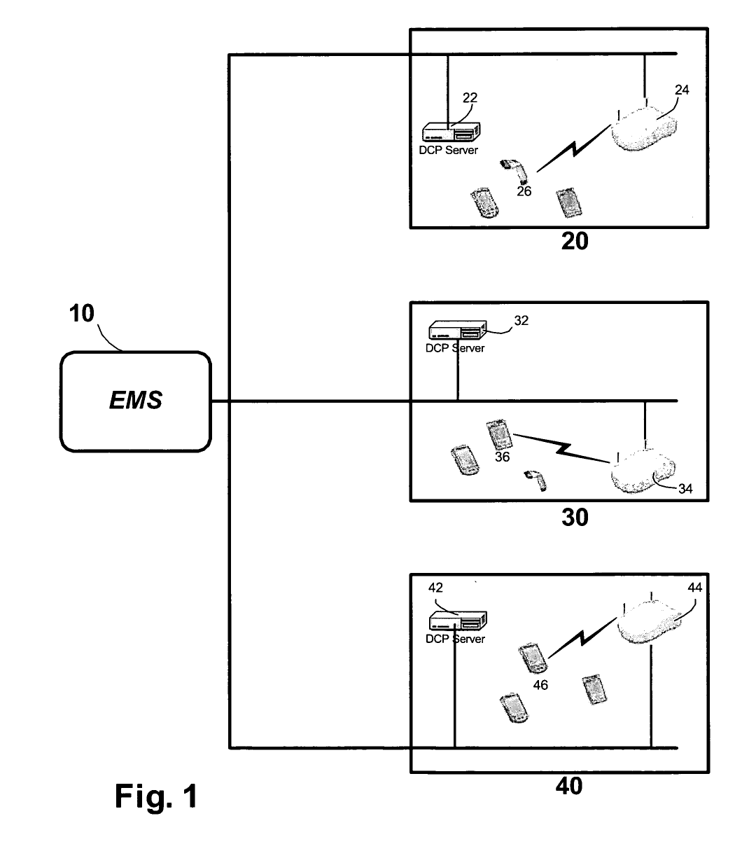

FIG. 1 illustrates an exemplary embodiment of a system according to the present invention. In particular, FIG. 1 shows sites 20, 30, 40 which utilize mobile devices 26, 36, 46. Exemplary sites 20, 30, 40 may include a store, factory, distribution center, warehouse location, etc. In an alternative embodiment, sites 20, 30, 40 may be, for example, areas and/or departments within a store, factory, distribution center, warehouse location, etc. Thus, in the alternative embodiment a plurality of sites 20, 30, 40 may exist within a single location.

Mobile devices 26, 36, 46 may be any type of mobile device such as handheld computers, bar code scanners, laptop computers, beepers, mobile phones, personal digital assistants, WAN radios, etc. Examples of uses within a typical site 20, 30, 40 of mobile devices 26, 36, 46 include, but are not limited to, barcode scanning, price tagging, inventory management, communication, etc. To efficiently monitor and track mobile devices 26, 36, 46 within the sites 20, 30, 40, the exemplary embodiment of the present invention utilizes an automated direct-connection protocol system and method for tracking mobile devices 26, 36, 46 based on location.

Specifically, the invention utilizes direct-connection protocol servers 22, 32, 42 (“DCP server”) associated with each site 20, 30, 40 as a reference to locate mobile devices 26, 36, 46. Examples of a DCP server 22, 32, 42 may include, for example, a file transfer protocol server (“FTP server”) or a trivial file transfer server (“TFTP server”). FTP and TFTP servers use standard Internet protocols to transfer files between computers. More specifically, a computer or mobile device may make a request for connection to a FTP or TFTP server to which the server responds by accepting or rejecting the request. Once the request is accepted, a connection is made (e.g., locally or via the Internet) between the requesting device and the accepting server. The FTP/TFTP protocols may then be used to send, receive, store and access files of any size from any connected devices, such as a plurality of mobile devices to a computer and/or database server.

The DCP servers 22, 32, 42 are utilized primarily for provisioning mobile devices 26, 36, 46. Typically, they stage the configuration and firmware images that the mobile devices 26, 36, 46 may download. However, the DCP servers 22, 32, 42 may be utilized for any network function.

The above description focuses on an implementation for a direct-connection protocol (e.g., FTP/TFTP) accessible through a local or Internet connection. However, other aspects of the invention may be readily adapted to other communication networks, including, but not limited to, other wide area networks (WANs), local area networks (LANs), and a wireless Internet interface. For purposes of simplifying the present disclosure, embodiments are described herein, primarily with reference to local area network embodiments. However, as would be understood by those skilled in the art, aspects of the invention may be employed in other suitable network environments.

In the embodiment shown in FIG. 1, DCP servers 22, 32, 42 may be situated, for example, in an area within sites 20, 30, 40 to which they are associated. In this embodiment, sites 20, 30, 40 encompass an entire location such as a store, factory or warehouse of a retail organization. For example, a warehouse in its entirety may be designated as site 20 which hosts a single DCP server 22, as shown in FIG. 1. The advantage of this embodiment is that mobile device 26 may be tracked based on geographical location, such as various store locations of a retail organization. As would be understood by those skilled in the art, DCP servers 22, 32, 42 need not be physically situated within the sites 20, 30, 40 to which they are associated. For example, DCP server 22 may be situated in a central location (not shown) remote from site 20.

As shown in FIG. 1, the mobile devices 26, 36, 46 connect to a wireless infrastructure device (“WID”) 24, 34, 44 to communicate with a wired infrastructure portion of the network. Examples of a WID 24, 34, 44 may include, for example, a wireless access point, a wireless switch, etc. The connection between mobile devices 26, 36, 46 and WIDs 24, 34, 44 may be established, for example, over a wireless local area network (“WLAN”) using various wireless technologies, such as Bluetooth, IEEE 802.11b, or some other known wireless communication protocol.

In FIG. 1, the wired infrastructure portion is shown as including the WIDs 24, 34, 44, the DCP servers 22, 32, 42 and the EMS 10 (described below. Those of skill in the art will understand that the wired infrastructure portion of the network may include any number of network devices such as network servers, network appliances, wired switches, routers, etc. to accomplish the goals of the network.

The exemplary embodiment of the network may further include an enterprise management system (“EMS”) 10. The EMS 10 may be, for example, a centralized console (e.g. a network appliance) which includes a mobile device management software platform. An example of such a software platform is the Symbol Technologies' Mobility Services Platform (“MSP”) which includes the capability of automatically managing the entire network including the mobile devices 26, 36, 46, the WIDs 24, 34, 44 and the DCP servers 22, 32, 42, in addition to other network devices.

When a user creates a site that is to be managed by the EMS 10 (e.g., site 20), the user may specify the DCP server address (e.g, DCP server 22) that is to be associated with that site. Thus, the EMS 10 may store information relating to the association between DCP servers 22, 32, 42 and their respective sites 20, 30, 40. Similar to all or most network devices, the DCP servers 22, 32, 42 are assigned a unique address, e.g., an Internet Protocol (“IP”) address. The EMS 10 may store information that relates the IP address of the DCP server to the site to which it is associated. Those of skill in the art will understand that there may be other manners of uniquely identifying the DCP servers 22, 32, 42 and associating these unique IDs with their respective sites 20, 30, 40.

Each mobile device 26, 36, 46 may include an EMS agent which is responsible for interfacing the mobile device 26, 36, 46 to the EMS 10. When the network is set up or when a mobile device is added to the network, the EMS 10 may discover the mobile device based on communication(s) received from the agent. In the example of FIG. 1, the EMS agent on the mobile devices 26 may communicate via the WID 24 with the EMS 10, thereby allowing the EMS 10 to discover and maintain a record corresponding to each of the mobile devices 26.

During operation, the agent may collect data from the mobile devices 26, 36, 46 (e.g., model number, software application version numbers, battery level, network throughput values, etc.) and forward this information to the EMS 10. The EMS 10 may then collect this information to monitor and manage the mobile devices 26, 36, 46 and the entire network. Those of skill in the art will understand that the EMS 10 may receive and maintain any type of data (e.g., management data, configuration data, performance data, etc.) for each of the mobile devices 26, 36, 46.

Part of this management may include that the EMS 10 may maintain configuration profiles for the mobile devices 26, 36, 46. The EMS 10 may communicate this profile (or data corresponding to the profile) to the EMS agent residing on each of the mobile devices 26, 36, 46. A portion of this configuration data may include provisioning information that includes the DCP server to which the mobile device should apply to receive the correct provisioning package. For example, the configuration instructions may instruct the EMS agent running on mobile device 46 to retrieve software applications from DCP server 42 based on the configuration profile maintained by the EMS 10 for mobile device 46. Thus, the EMS agent of the mobile device 46 will apply to the DCP server 42 for the correct provisioning package and this data will be downloaded onto the mobile device 46.

Examples of what the configuration profile may include, for example, are a notion of what software applications (i.e., version updates, firmware images, security patches, etc.) are needed for particular mobile devices 26, 36, 46. The configuration profile is tailored to meet the needs of the particular device invoking the profile. For example, mobile device 36 may have software application needs different from other mobile devices 26, 46 because of the function it serves and/or the site 30 it is located and/or the area within site 30 it is located. The EMS 10 maintains a record of the correct software applications for a certain type of mobile device 26, 36, 46 and/or a certain site 20, 30, 40 and/or a certain area within a site 20, 30, 40. The software applications may be stored on the DCP servers 22, 32, 42 and the configuration instructions may include instructions for locating those DCP servers 22, 32, 42 to enable mobile devices 26, 36, 46 to retrieve the updated software applications.

In addition, the EMS agent on each mobile device may periodically upload a file and/or information onto the DCP server. The file/information may include identifying and status information associated with mobile device. For example, the file may include information that identifies the device (i.e., MAC address, IP address, model, serial number, firmware/OS version, etc.), as well as monitored information (i.e., battery status, signal strength, temperature, etc.).

The EMS 10 may then periodically poll the DCP servers 22, 32, 42 for the file/information. If the file is present, the EMS 10 consumes the file/information. The EMS 10 uses the information contained in these files to update the mobile device record in the EMS 10 database accordingly.

As can be seen from the above description, the EMS 10 will have data that relates each DCP server 22, 32, 42 to its corresponding site 20, 30, 40. Thus, when the EMS 10 retrieves the mobile device file from the DCP server, the EMS may infer that the mobile device is located at the site that corresponds to DCP server from which the file was retrieved. Accordingly, the EMS 10 may track the location of the mobile devices based on the known location of the DCP servers.

In addition, if there is a change to the location of a mobile device 26, 36, 46, the EMS 10 may update the record corresponding to mobile devices 26, 36, 46. The EMS 10 may notify and/or alert (e.g., visually via computer monitor) an EMS 10 user of such changes. For example, if new location information received by the EMS 10 concerning mobile device 46 differs from information already stored in the EMS 10, the new information will replace the old information reflecting the present location of mobile device 46. Similarly, if the file corresponding to mobile device 36 is known by the EMS 10 to be located in site 30 but DCP server 32 does not send the file requested, that particular device will be known to have moved from site 30. Accordingly, the information corresponding to the location of mobile device 36 will be updated in the mobile device table.

In both of the above described scenarios, the EMS 10 may then make an indication to the EMS user of the change in location of the mobile device. In this manner, mobile devices 26, 36, 46 may be tracked for movement to and from different sites 20, 30, 40. For an entity such as a retail organization, this may include tracking movement of mobile devices 26, 36, 46 to and from various stores or tracking movement of mobile devices 26, 36, 46 to and from departments and/or floors within a particular store.

In this way, the EMS 10 may serve as a central repository for location information associated with mobile devices 26, 36, 46 by constantly updating the identifying information corresponding to each mobile device 26, 36, 46 thereby associating them with a particular site 20, 30, 40. For example, if a file containing identity information associated with mobile device 26 is sent to the MSP via the second connection from DCP server 22, then mobile device 26 is determined to be at site 20. Therefore, based on the maintained association between DCP servers 22, 32, 42 and sites 20, 30, 40, the location of mobile device 26 may be inferred. The advantage of this approach is that the location of mobile devices 26, 36, 46 is discovered automatically. Thus, the need for special appliances (e.g., security monitor devices, control computers, metal security tags, etc.) within sites 20, 30, 40 is eliminated.

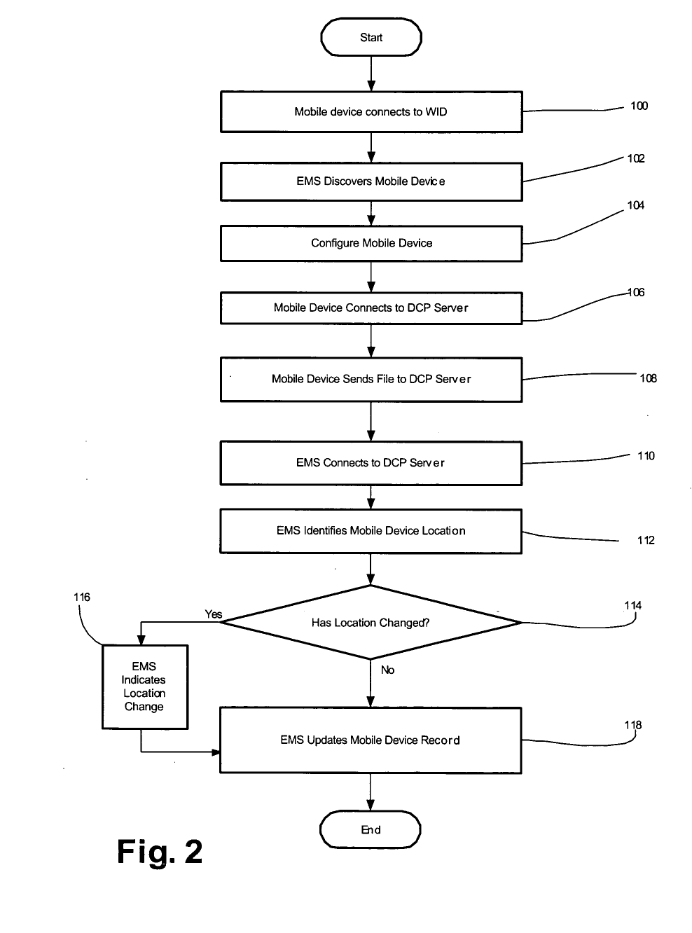

FIG. 2 shows a flow chart describing a method according to the exemplary embodiment of the present invention utilized to locate mobile devices 26, 36, 46. The method will be described in the context of a single site 20 comprising a single DCP server 22, a single WID 24 and a single mobile device 26. Those skilled in the art will understand that other systems having varying configurations, for example, different numbers of sites, DCP servers, WIDs, and mobile devices may also be used to implement the exemplary method.

In step 100, the MSP agent running on mobile device 26 wirelessly associates with the WID 24 allowing the EMS agent on the device 26 to communicate with the EMS 10. The EMS 10 may then collect information sent by the EMS agent on the mobile device 26 allowing the EMS 10 to discover the mobile device 26 (step 102). The EMS 10 may, for example, create a new record in a database (or other storage means) to store information relating to the mobile device 26. Thus, as new information that relates to the mobile device 26 is received at the EMS 10, this information may be stored in the corresponding record. As described above, the information may be received directly (e.g., from the mobile device 26 via the WID 24) or indirectly (e.g., via a file retrieved from the DCP server 22).

After the mobile device 26 has been discovered by the EMS 10, the mobile device 26 may then be configured in step 104. The particular manner of configuration is not relevant to the exemplary embodiment of the present invention. Examples of device configuration procedures may include that the EMS 10 stores a configuration profile that is associated with a particular WID. Thus, when the EMS 10 discovers the mobile device 26 is communicating with the WID 24, the EMS 10 may then send the configuration profile associated with the WID 24 to the mobile device 26. In another example, the EMS 10 may store a configuration profile based on the type of the mobile device 26 and upon discovering the type of the mobile device 26, the EMS 10 may send the appropriate configuration profile. Those of skill in the art will understand that numerous other manners of configuring a mobile device exist, e.g., manual configuration after discovery, profile request by the mobile device, etc., but that the particular type of configuration method is not important to the exemplary embodiment of the present invention.

However, as part of the configuration process, the EMS agent on the mobile device 26 will be directed to access the appropriate DCP server (e.g., DCP server 22) to obtain configuration and/or other information for the mobile device 26, e.g., provisioning information and files. Thus, in step 106, the mobile device 26 will connect with the DCP server 22 to obtain the requested/required files. In step 108, the EMS agent of the mobile device 26 will send a file and/or information which includes one or more identifying characteristics of the mobile device (e.g., MAC address, IP address, serial number, etc.) to the DCP server 22. This uploading of the file may be performed continuously or periodically and is facilitated by the EMS agent running on mobile device 26. The DCP server 22 will store this file/information.

In step 110, EMS 10 connects with the DCP server 22 and requests all the files/information that the DCP server 22 has collected for mobile devices. This connection may be performed periodically by the EMS 10. The DCP server 22 will send the files/information to the EMS 10 which will store the information in the record corresponding to the identified mobile device. However, as described above, the EMS 10 also has data indicating the relationship between the DCP server 22 and the site 20. Thus, the EMS 10 may infer that any files identifying a mobile device which are retrieved from the DCP server 22 locates that mobile device at site 20. Thus, in step 112, the EMS 10 identifies the location of the mobile device 26 based on the files that is retrieved from the DCP server 22.

In step 114, the EMS 10 determines whether the location of the mobile device 26 has changed since its location was last determined by the EMS 10. If the location has changed, the EMS 10 may provide an indication of the changed location to a user of the EMS 10 (step 116) and the updates the corresponding mobile device record to indicate the current location (step 118). If the location has not changed, the information from the file is used to update the corresponding record and the location information is confirmed. Thus, at the completion of the exemplary process, the EMS 10 has both discovered and located the mobile device 26.

In addition, it should be clear from the above description that it is also possible to determine if a mobile device was previously located at a site, but is no longer there. For example, if a file identifying mobile device 26 was previously retrieved from the DCP server 22, but the current retrieving of files did not include a file corresponding to the mobile device 26, the EMS 10 may infer that the mobile device 26 is no longer at the site 20. The EMS 10 may provide the EMS 10 user with an indication that the mobile device 26 is no longer at its previous location.

Those of skill in the art will understand that the above described process is only exemplary and that steps may be added or deleted from the process or alternative steps may be used to accomplish the same discovery and location function. For example, in one exemplary alternative embodiment, the discovery of the mobile device 26 may be effected by the finding of the file/information on the DCP server 22 by the EMS 10, i.e., there is no direct communication between the EMS 10 and the mobile device 26.

Furthermore, in the above description, it was described that the mobile devices included an EMS agent. Those of skill in the art will understand that the EMS agent is not a necessary component of the exemplary embodiment. The mobile device may provide the DCP server with the necessary identifying information without the need for the EMS agent.

There are many modifications to the present invention which will be apparent to those skilled in the art without departing from the teaching of the present invention. The embodiments disclosed herein are for illustrative purposes only and are not intended to describe the bounds of the present invention which is to be limited only by the scope of the claims appended hereto.

1. A method, comprising:
retrieving information from a direct connection protocol (“DCP”) server, the information including a unique identifier for a mobile device, wherein the DCP server received the information in a communication from the mobile device;
maintaining a correlation between the DCP server and a site; and
storing an indication that the mobile device is located at the site based on the retrieving of the information from the DCP server correlated to the site.

2. The method of claim 1, wherein the information is a file.

3. The method of claim 1, wherein the unique identifier is one of a MAC address, an IP address and a serial number.

4. The method of claim 1, further comprising:
communicating the address of the DCP server to the mobile device.

5. The method of claim 1, further comprising:
repeating the retrieving; and
updating the indication when the location of the mobile device has changed.

6. The method of claim 1, further comprising:
providing an alert when the location of the mobile device has changed.

7. A system, comprising:
a mobile device;
a direct connection protocol (“DCP”) server receiving information from the mobile device, wherein the information includes a unique identifier for the mobile device; and
an enterprise management system maintaining a correlation between the DCP server and a site, wherein the enterprise management system retrieves the information and determines a location for the mobile device based on the correlation and the unique identifier, the enterprise management system storing the location of the mobile device.

8. The system of claim 7, wherein the information is a file.

9. The system of claim 7, wherein the mobile device is one of a mobile computer, a bar code scanner, a radio frequency identification reader, a mobile communication device and a personal digital assistant.

10. The system of claim 7, wherein the DCP server is one of a file transfer protocol server and a trivial file protocol server.

11. The system of claim 7, wherein the enterprise management system resides on one of a network server and a network appliance.

12. The system of claim 7, wherein the DCP server provides provisioning information to the mobile device.

13. The system of claim 7, wherein the mobile device includes an enterprise management agent.

14. The system of claim 7, wherein the information further includes one of configuration data, performance data and management data.

15. The system of claim 7, wherein the enterprise management system stores the location in a record corresponding to the mobile device.

16. A method, comprising:
storing a plurality of records, each record corresponding to a mobile device connected to a network;
storing a plurality of correlations between a plurality of sites and a plurality of direct connection protocol (“DCP”) servers;
retrieving information from one of the DCP servers, wherein the information includes a unique identifier for at least one of the mobile devices; and
storing location data in the record corresponding to the at least one mobile device, wherein the location data is determined based on the correlation between the one of the DCP servers and the corresponding site.

17. The method of claim 16, further comprising:
providing an location data to a user.

18. The method of claim 16, wherein the mobile devices are wireless devices.

19. The method of claim 16, wherein the information is a file.

20. The method of claim 16, further comprising:
discovering the one of the mobile devices.
